(19) United States
(12) Patent Application Publication
(10) Pub. No.: US 2007/0196069 A1
(43) Pub. Date: Aug. 23, 2007

(54) OPTICAL CONNECTOR CLEANING METHOD, CLEANING FIXTURE, CLEANING FIXTURE UNIT AND OPTICAL CONNECTOR

(75) Inventors: Masashi SHIBATA, TOKYO (JP); Toshiyuki OKAYASU, TOKYO (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 11/685,744

(22) Filed: Mar. 13, 2007

Related U.S. Application Data
(63) Continuation of application No. PCT/JP05/16860, filed on Sep. 13, 2005.

(30) Foreign Application Priority Data
Sep. 15, 2004 (JP) 2004-268936

(51) Int. Cl. G02B 6/00

(52) U.S. Cl. 385/134; 134/30

(57) ABSTRACT

There is provided an optical connector cleaning method for cleaning a ferrule of an optical connector, having a spraying step of spraying cleaning solvent on the ferrule and a removing step of blowing away the solvent by blowing air before the solvent dries. The optical connector cleaning method may further include a fitting step of fitting a fitting section of a cleaning fixture into the optical connector before the spraying step. Still more, in the removing step, the air and solvent may be flown to through holes provided around the ferrule by blowing the air against the front of the ferrule. Thereby, the cleaning cost per optical connector may be suppressed low and a difference in terms of quality of cleaning among cleaning operators may be reduced.

### CROSS REFERENCE TO RELATED APPLICATIONS

This is a continuation application of PCT/JP2005/016860 filed in PCT on Sep. 13, 2005 which claims priority from a Japanese Patent Application(s) No. 2004-268936 filed on Sep. 15, 2004 in JP, the contents of which are incorporated herein by reference.

### BACKGROUND

1. Field of the Invention

The present invention relates to an optical connector cleaning method, a cleaning fixture, a cleaning fixture unit and an optical connector. More specifically, the invention relates to an optical connector cleaning method and to a cleaning fixture, a cleaning fixture unit and an optical connector for use in the optical connector cleaning method.

2. Related Art

Conventionally, as a method for cleaning a ferrule of an optical connector, there has been used a method of wiping dirt such as dust adhering on the ferrule by a lint-free cloth moistened by alcohol. Also as another method for cleaning the ferrule of the optical connector, there has been used a method of wiping the dirt of the ferrule by using a cleaning fixture made from a cleaning cloth fabricated in a form of a reel or stick.

The present applicant is unaware of existence of documents of the prior art, so that description of the document of the prior art will be omitted here.

However, in case of the method of wiping the ferrule by the lint-free cloth moistened by alcohol, it is not easy to completely remove the dirt on the ferrule and there has been a difference in terms of quality of the cleaning among cleaning operators. Still more, a cleaning cost per optical connector has been high when the cleaning fixture is used, so that a low cost cleaning method has been desired.

Accordingly, it is an object of the invention to provide an optical connector cleaning method, a cleaning fixture, a cleaning fixture unit and an optical connector which are capable of solving the above-mentioned problems. This object may be achieved through the combination of features described in independent claims of the invention. Dependent claims thereof specify preferable embodiments of the invention.

### SUMMARY

In order to solve the above-mentioned problems, according to a first aspect of the invention, there is provided an optical connector cleaning method for cleaning a ferrule of an optical connector, having a spraying step of spraying cleaning solvent on the ferrule and a removing step of blowing away the solvent by blowing air before the solvent dries.

The optical connector cleaning method may further include a fitting step of fitting a fitting section of a cleaning fixture into the optical connector before the spraying step.

In the removing step, the air and solvent may be flown to through holes provided around the ferrule by blowing air against the front of the ferrule.

According a second aspect of the invention, there is provided a cleaning fixture for cleaning a ferrule of an optical connector, having a fitting section to be fitted into the optical connector, an air discharge section provided at position where it can blow air against the ferrule when the fitting section is fitted into the optical connector and a solvent mixing section for spraying solvent on the ferrule by mixing the solvent for cleaning the ferrule with air.

The cleaning fixture may further include through holes provided between the optical connector for releasing the air to the outside of the optical connector when the fitting section is fitted into the optical connector.

The optical connector may have a receptacle for holding the ferrule and the fitting section may be provided on an outer face of the air discharge section so that the outer face is fitted into the receptacle.

According to a third aspect of the invention, there is provided a cleaning fixture unit for cleaning a connector unit in which a plurality of cable-side optical connectors are arrayed to connect with a communication substrate in which a plurality of substrate-side optical connectors are provided, including a guide plate inserted into a guide rail provided to insert the communication board and a plurality of cleaning fixtures provided on the guide plate at position facing to each of the cable-side optical connectors, wherein each of the cleaning fixture has an air discharge section provided at position where it can spray air on a ferrule of the cable-side optical connector and a solvent mixing section for mixing solvent for cleaning the ferrule with air to spray the solvent on the ferrule.

In the cleaning fixture unit, each of the cleaning fixtures may have a fitting section for fitting into the cable-side optical connector and the air discharging section may be provided at position where it can spray air on the ferrule when the fitting section is fitted into the cable-side optical connector.

According to a fourth aspect of the invention, there is provided an optical connector, having a ferrule and a receptacle for holding the ferrule, wherein the receptacle has through holes for releasing air sprayed on the ferrule to the outside of the receptacle around the ferrule.

The receptacle may hold a plurality of ferrules and the through holes may be provided around each of the plurality of ferrules.

It is noted that the summary of the invention described above does not necessarily describe all necessary features of the invention. The invention may also be a sub-combination of the features described above.

Thus, the invention enables the cleaning cost per optical connector to be suppressed low and the difference of quality of cleaning among the cleaning operators to be reduced.

### BRIEF DESCRIPTION OF DRAWINGS

FIG. 1 is a drawing showing one example of a cleaning fixture 10 according to a first embodiment of the invention.

FIG. 2 is a drawing showing one example of an optical connector 20 according to the first embodiment of the invention.

FIG. 3 is a drawing showing one example a receptacle 30 according to the first embodiment of the invention.

FIG. 4 is a flowchart showing one exemplary flow of a process in an optical connector cleaning method according to the first embodiment of the invention.

FIG. 5 is a drawing showing one example of a connector unit 40 according to a second embodiment of the invention.

FIG. 6 is a drawing showing one example of a section of a cleaning fixture unit 50 according to the second embodiment of the invention.

FIG. 7 is a drawing showing one example of a cleaning fixture 510 according to the second embodiment of the invention.

FIG. 8 is one exemplary detailed drawing of a range 45 shown in FIG. 5.

### DESCRIPTION OF EXEMPLARY EMBODIMENTS

The invention will now be described based on preferred embodiments, which do not intend to limit the scope of the invention, but exemplify the invention. All of the features and the combinations thereof described in the embodiments are not necessarily essential to the invention.

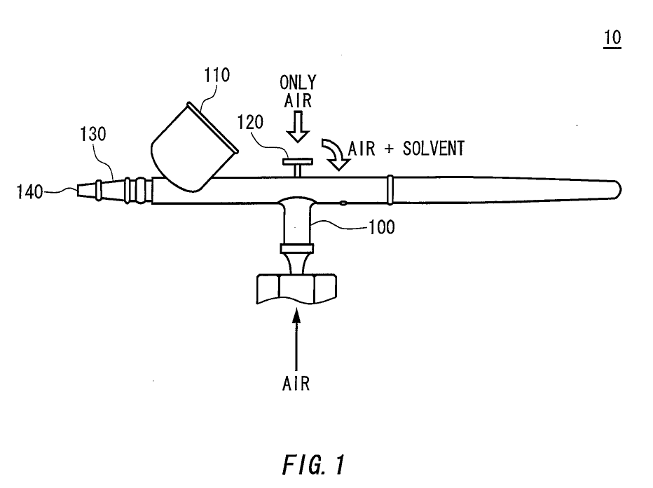

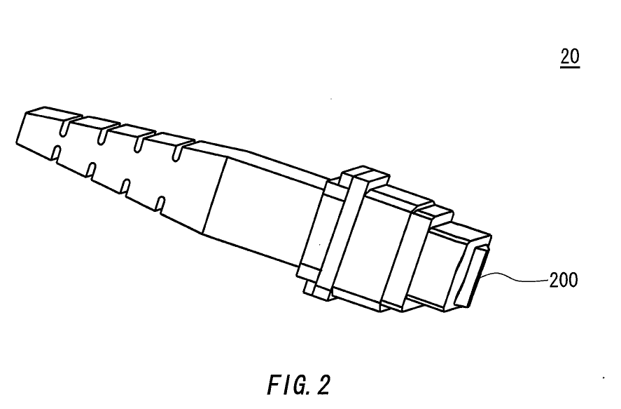

FIG. 1 is a drawing showing one example of a cleaning fixture 10 according to a first embodiment of the invention. FIG. 2 is a drawing showing one example of an optical connector 20 according to the first embodiment of the invention. The cleaning fixture 10 shown in FIG. 1 is used to clean a ferrule 200 of the optical connector 20 as shown in FIG. 2 for example. The cleaning fixture 10 of the first embodiment of the invention is used for the purpose of lowering a cleaning cost per optical connector in cleaning the ferrule 200 of the optical connector 20 and of reducing a difference in terms of quality of the cleaning among cleaning operators.

The cleaning fixture 10 has an air inlet section 100, a solvent tank 110, a spraying lever 120, a solvent mixing section 130 and an air discharging section 140. The air inlet section 100 is connected with a compressor for example to taken air into the cleaning fixture 10. The solvent tank 110 holds solvent for cleaning the ferrule 200. Here, the solvent may be fluorine cleaning agent for example or may be organic solvent such as ethanol, IPA and acetone. The spraying lever 120 controls air and solvent spraying operations of the cleaning fixture 10. In concrete, the cleaning fixture 10 performs different spraying operations when the spraying lever 120 is pressed and when it is laid rearward, respectively. When the spraying lever 120 is laid rearward, the solvent mixing section 130 mixes the solvent held in the solvent tank 110 with air taken in through the air inlet section 100 to spray the solvent on the ferrule 200 via the air discharge section 140. When the spraying lever 120 is laid rearward, the air discharge section 140 discharges the air with which the solvent is mixed in the solvent mixing section 130 to spray on the ferrule 200. When the spraying lever 120 is pressed, the air discharge section 140 discharges only air taken in through the air inlet section 100 to spray on the ferrule 200.

The cleaning fixture 10 of the first embodiment enables one to mix the solvent and air for cleaning the ferrule 200 to spray on the ferrule 200 and to blow only air against the ferrule 200.

Accordingly, the cleaning fixture 10 enables one to clean the ferrule 200 by blowing only air against the ferrule 200 after cleaning dirt of the ferrule 200 by spraying the solvent mixed with air on the ferrule 200 to blow out the solvent and dry the ferrule 200.

Still more, because the cleaning fixture 10 enables one to clean the ferrule 200 by using only the air and cleaning solvent, its use allows the cleaning cost per optical connector to be suppressed low as compared to the case of using the conventional cleaning fixture using a cleaning cloth fabricated into the shape of a reel or stick.

Still more, because the cleaning fixture 10 enables one to clean the ferrule 200 just by spraying air and solvent on the ferrule 200, it enables one to clean the ferrule 200 more easily and favorably as compared to the case of using the conventional cleaning fixture and cleaning method. It then reduces the difference in terms of quality of the cleaning among the cleaning operators.

It is noted that the cleaning fixture 10 may further include a fitting section for fitting into the optical connector 20. In this case, the air discharge section 140 may be provided at position where it can spray air and solvent on the ferrule 200.

Because the ferrule 200 may be cleaned steadily and favorably by fitting the cleaning fixture 10 into the ferrule 200 and by spraying air and solvent on the ferrule 200, it becomes possible to further reduce the difference in terms of quality of the cleaning among the cleaning operators.

Still more, the fitting section of the cleaning fixture 10 may have a through portion for releasing the air and solvent to the outside of the optical connector 20 between the optical connector 20 when it is fitted into the optical connector 20. For example, when the fitting section is fitted into the optical connector 20, the air and solvent may be released to the outside of the optical connector 20 by forming a groove having a width that is capable of fully passing the air and solvent between the optical connector 20.

Thereby, even when the cleaning fixture 10 is fitted with the optical connector 20, the air and solvent may be flown to the outside via the through portion, so that the cleaning may be carried out favorably without remaining dirt such as dust within the optical connector 20.

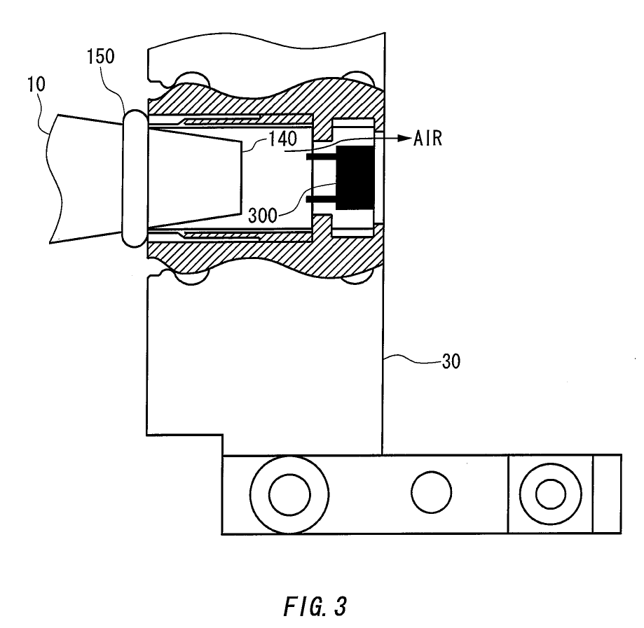

Next, a case when the optical connector has a receptacle for holding the ferrule will be explained. FIG. 3 shows one example of the receptacle 30 of the embodiment. The receptacle 30 holds a ferrule 300. In the receptacle 30 shown in the figure, the ferrule 300 is cleaned from the left side in the figure through a hollow portion. When the cleaning fixture 10 shown in FIG. 1 is used for example, the ferrule 300 is cleaned by air and solvent sprayed from the air discharge section 140 provided at an edge of the cleaning fixture 10 inserted into the hollow portion.

Here, a fitting section 150 of the cleaning fixture 10 is provided on an outer face thereof and the outer face fits into the receptacle 30. Still more, the receptacle 30 has a through hole around the ferrule 300 to release air and solvent sprayed from the cleaning fixture 10 on the ferrule 300 to the outside of the receptacle 30 as shown in the figure.

When the ferrule 300 to be cleaned is held in a recess of the receptacle 30, the ferrule 300 cannot be fully cleaned even when the conventional stick-like cleaning fixture is used. However, the cleaning fixture 10 of the embodiment can clean the ferrule 300 held in the recess favorably because it can clean the ferrule 300 by directly spraying air and solvent thereon. Still more, it becomes possible to clean the ferrule 300 more steadily and favorably by fitting the cleaning fixture 10 with the receptacle 30.

Further, it becomes possible to clean the ferrule 300 favorably without remaining dirt such as dust on the ferrule 300 by flowing air and solvent to the through hole when the cleaning fixture 10 is fitted with the receptacle 30.

It is noted that the structure of the receptacle 30 is not limited to that shown in the figure and various modifications may be added to the structure shown in the figure. For example, the receptacle 30 may be constructed so as to hold a plurality of ferules. In this case, the receptacle 30 may have the through hole around each of the plurality of ferrules. Because the through hole is provided around each of the ferrules, the ferrules may be cleaned favorably continuously or in the same time by steadily flowing air and solvent to the outside of the receptacle 30.

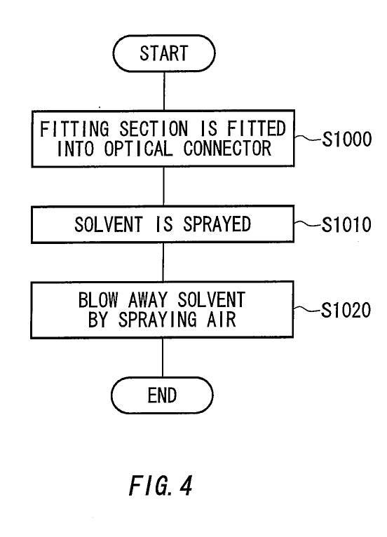

FIG. 4 is a flowchart showing one exemplary flow of processes in the optical connector cleaning method of the first embodiment. In the chart, the optical connector cleaning method for cleaning the optical connector by using the cleaning fixture 10 explained in FIGS. 1 through 3 will be explained stepwise. At first, the cleaning operator fits the fitting section of the cleaning fixture 10 into the optical connector having the ferrule to be cleaned in Step 1000.

Next, when the cleaning operator lays the spraying lever 120 rearward, the cleaning solvent is sprayed from the cleaning fixture 10 on the ferrule to be cleaned in Step 1010. Then, when the cleaning operator presses the spraying lever 120 before the sprayed solvent dries, the solvent is blown away or dried by air blown against the ferrule from the cleaning fixture 10 in Step 1020. When the through hole is provided around the ferrule, the cleaning fixture 10 may blow air against the front of the ferrule so as to flow the air and solvent to the through hole.

Thus, the ferrule may be cleaned by blowing air to blow away or dry the solvent after spraying the solvent on the ferrule to be cleaned by the optical connector cleaning method of the embodiment. Here, because the optical connector cleaning method allows the ferrule to be cleaned only by air and cleaning solvent, the cleaning cost per optical connector may be suppressed low. Still more, because the optical connector cleaning method enables one to clean the ferrule 200 just by spraying air and solvent on the ferrule 200 to be cleaned, the ferrule 200 may be cleaned easily and favorably.

Further, the cleaning can be achieved more easily, steadily and favorably by fitting the cleaning fixture 10 into the optical connector. Thus, it becomes possible to reduce the difference in terms of quality of cleaning among the cleaning operators by cleaning the ferrule of the optical connector by using the optical connector cleaning method.

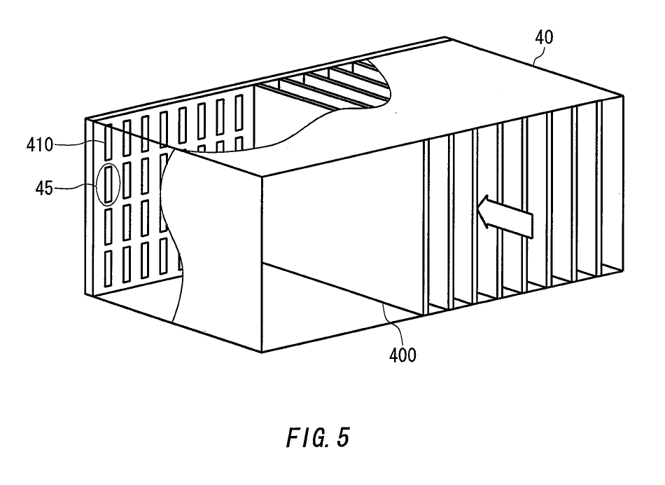

FIG. 5 shows one example of a connector unit 40 according to a second embodiment of the invention.

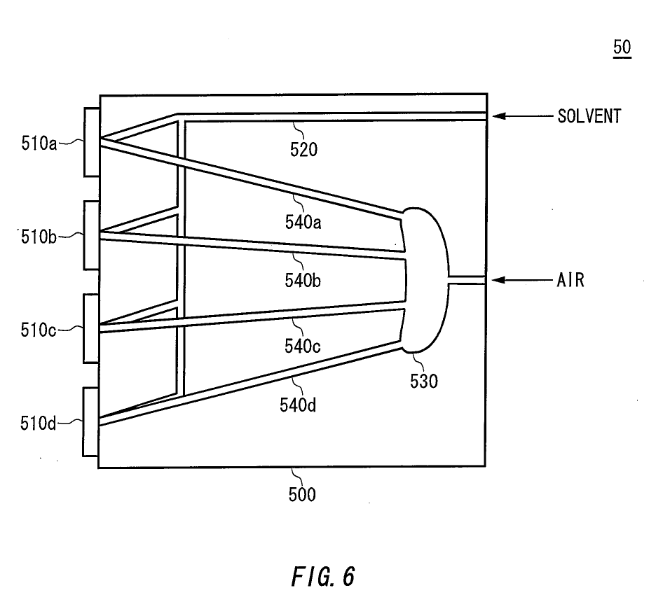

FIG. 6 shows one exemplary section of a cleaning fixture unit 50 according to a second embodiment of the invention. The connector unit 40 has a plurality of cable-side optical connectors 410 arrayed so as to connect with a plurality of communication substrates 400 in which substrate-side optical connectors are provided. The cleaning fixture unit 50 has a guide plate 500, a plurality of cleaning fixtures 510a, 510b, 510c and 510d (hereinafter referred to simply as 510), a solvent passage 520, an air reservoir 530 and a plurality of air passages 540a, 540b, 540c and 540d (hereinafter referred to simply as 540). The cleaning fixture unit 50 is inserted into the connector unit 40 to clean the plurality of ferrules of the cable-side optical connectors 410 provided in the connector unit 40. It is noted that the cleaning fixture unit 50 has the four cleaning fixtures 510 and the four air passages 540 in the figure.

However, the number of four is one exemplary number and the number of the cleaning fixture 510 and the air passage 540 of the cleaning fixture unit 50 of the embodiment is not limited to be four and may be a different number.

The guide plate 500 is inserted into a guide rail provided to insert the communication substrate 400 into the connector unit 40 instead of the communication substrate 400. Each of the cleaning fixtures 510 is provided on the guide plate 500 at position facing to each of the cable-side optical connector 410. The solvent passage 520 passes the solvent fed from the outside for cleaning the ferrules of the cable-side optical connectors 410 to feed to each of the cleaning fixture 510. The air reservoir 530 holds air to be fed from the outside. Each of the air passage 540 passes the air fed from the outside and held in the air reservoir 530 to feed to each of the cleaning fixtures 510. Here, each air passage 540 may be provided so that its length is almost equal with others. The air having the same pressure may be stably fed to all of the cleaning fixtures 510 by feeding the air fed from the outside by holding once in the air reservoir 530, not by supplying directly to each of the cleaning fixtures 510.

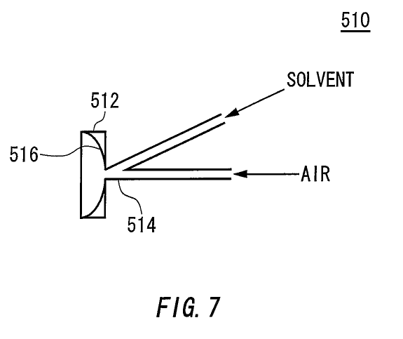

FIG. 7 shows one example of the cleaning fixture 510 of the second embodiment. Each of the cleaning fixtures 510 has a fitting section 512, a solvent mixing section 514 and an air discharge section 516. The fitting section 512 is fitted into the cable-side optical connector 410. The solvent for cleaning the ferrule of the cable-side optical connector 410 fed through the solvent passage 520 is mixed with air fed through the air passage 540 in the solvent mixing section 514 and is then sprayed on the ferrule via the air discharge section 516.

The air discharge section 516 is provided at position where it can spray the air and solvent on the ferrule of the cable-side optical connector 410. In concrete, the air discharge section 516 is provided at the position where it can spray the air and solvent on the ferrule when the fitting section 512 is fitted into the cable-side optical connector 410. Then, under an instruction of a user operating the cleaning operation, the air discharge section 516 is caused to spray the solvent mixed with air in the solvent mixing section 514 on the ferrule and after spraying the solvent, to blow only air fed through the air passage 540 against the ferrule to blow away the solvent.

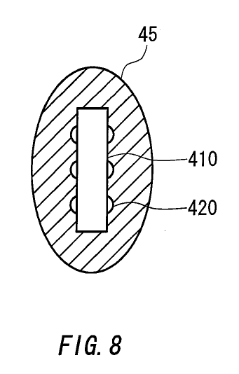

FIG. 8 is one exemplary detailed view of a range 45 shown in FIG. 5. The connector unit 40 may have through holes 420 around the cable-side optical connector 410 as shown in the figure for example. The connector unit 40 releases the air and solvent sprayed on the ferrule of the cable-side optical connector 410 by each of the cleaning fixtures 510 to the outside of the connector unit 40 through the through holes 420.

According to the cleaning fixture unit 50 of the second embodiment, the optical connector may be cleaned without removing the cables from the connector unit 40 even when a plurality of optical connectors are arrayed in high density like the connector unit 40 shown in FIG. 5.

Thereby, it becomes possible to prevent an increase of time that is otherwise required for the cleaning operation to pull and insert the cables and a mistake of inserting the cable into an erroneous spot from occurring.

Still more, the cleaning may be carried out more easily, steadily and favorably by fitting the cleaning fixture 510 into the cable-side optical connector 410.

Further, the time required for cleaning the optical connectors in the whole connecting unit 40 may be shortened because the plurality of cable-side optical connectors 410 may be cleaned in parallel by using the plurality of cleaning fixtures 510.

Although the invention has been described by way of the exemplary embodiments, it should be understood that those skilled in the art might make many changes and substitutions without departing from the spirit and scope of the invention. It is obvious from the definition of the appended claims that the embodiments with such modifications also belong to the scope of the invention.

As described above, the invention enables the cleaning cost per optical connector to be suppressed low and the difference of quality of cleaning among the cleaning operators to be reduced.

What is claimed is:

1. An optical connector cleaning method for cleaning a ferrule of an optical connector, comprising:
a spraying step of spraying cleaning solvent on said ferrule; and
a removing step of blowing away said solvent by blowing air before said solvent dries.

2. The optical connector cleaning method as set forth in claim 1, further comprising a fitting step of fitting a fitting section of a cleaning fixture into said optical connector before said spraying step.

3. The optical connector cleaning method as set forth in claim 2, wherein said removing step is a step of flowing the said air and solvent to through holes provided around said ferrule by blowing said air against the front of said ferrule.

4. A cleaning fixture for cleaning a ferrule of an optical connector, comprising:
a fitting section to be fitted into said optical connector;
an air discharge section provided at position where it can blow air against said ferrule when said fitting section is fitted into said optical connector; and
a solvent mixing section for spraying solvent on said ferrule by mixing said solvent for cleaning said ferrule with air.

5. The cleaning fixture as set forth in claim 4, further comprising through holes provided between said optical connector for releasing said air to the outside of said optical connector when said fitting section is fitted into said optical connector.

6. The cleaning fixture as set forth in claim 5, wherein said optical connector has a receptacle for holding said ferrule; and
said fitting section is provided on an outer face of said air discharge section so that said outer face is fitted into said receptacle.

7. A cleaning fixture unit for cleaning a connector unit in which a plurality of cable-side optical connectors are arrayed to connect with a communication substrate in which a plurality of substrate-side optical connectors are provided, comprising:
a guide plate inserted into a guide rail provided to insert said communication board; and
a plurality of cleaning fixtures provided on said guide plate at position facing to each of said cable-side optical connectors; wherein
each of said cleaning fixtures has an air discharge section provided at position where it can spray air on a ferrule of said cable-side optical connector; and
a solvent mixing section for mixing solvent for cleaning said ferrule with air to spray said solvent on said ferrule.

8. The cleaning fixture unit as set forth in claim 7, wherein each of said cleaning fixtures has a fitting section for fitting into said cable-side optical connector; and
said air discharging section is provided at position where it can spray air on said ferrule when said fitting section is fitted into said cable-side optical connector.

9. An optical connector, comprising:
a ferrule; and
a receptacle for holding said ferrule; wherein
said receptacle has through holes for releasing air sprayed on said ferrule to the outside of said receptacle around said ferrule.

10. The optical connector as set forth in claim 9, wherein said receptacle holds a plurality of said ferrules and said through holes are provided around each of said plurality of ferrules.
